(19) United States
(12) Patent Application Publication
(10) Pub. No.: US 2026/0339999 A1
(43) Pub. Date: Oct. 29, 2026

(54) INTELLIGENT QUESTION ANSWERING METHOD AND APPARATUS BASED ON LARGE MODEL, DEVICE, MEDIUM AND PRODUCT

(71) Applicant: Beijing Volcano Engine Technology Co., Ltd., Beijing (CN)

(72) Inventors: Qi SU, Beijing (CN); Jia LIU, Beijing (CN); Mengran LI, Beijing (CN); Chonglin TANG, Beijing (CN); Jiacong LV, Beijing (CN)

(21) Appl. No.: 19/658,247

(22) Filed: Apr. 24, 2026

(30) Foreign Application Priority Data
Apr. 25, 2025 (CN) 202510536244.X

(51) Int. Cl. G06F 16/3329

(52) U.S. Cl. CPC G06F 16/33295

(57) ABSTRACT

Provided are an intelligent question answering method and apparatus based on a large model, and a device, a medium and a product, which relate to the field of data processing technology, artificial intelligence technology, large model technology and large language model technology. The method includes: in response to an input instruction of a question answering task, displaying a first question in a first area of an interaction page; in response to the first question, displaying a first reply plan for the first question in a second area of the interaction page; in response to a modification instruction for the first reply plan, triggering modification of the first reply plan and displaying a second reply plan in the second area; and displaying, in the first area, an answer obtained based on the second reply plan.

### CROSS-REFERENCE TO RELATED APPLICATIONS

This application claims priority to Chinese Application No. 202510536244.X filed Apr. 25, 2025, the disclosure of which is incorporated herein by reference in its entirety.

### TECHNICAL FIELD

The present disclosure relates to the field of data processing technology, artificial intelligence technology, large model technology and large language model technology, and in particular, to an intelligent question answering method and apparatus based on a large model, a device, a medium and a product.

### BACKGROUND

The interaction process between a user and an intelligent system is that the user gives a question, and the intelligent system gives an answer after thinking according to the question given by the user. Generally, a thinking process and a final answer are displayed on an interaction page. That is, the accuracy of the answer given by the intelligent system depends on the thinking process.

### SUMMARY

In view of this, the present disclosure provides an intelligent question answering method and apparatus based on a large model, a device, a medium and a product to solve the problem of accuracy of intelligent question answering.

In a first aspect, the present disclosure provides an intelligent question answering method based on a large model, including:
displaying a first question in a first area of an interaction page in response to an input instruction of a question answering task;
displaying a first reply plan for the first question in a second area of the interaction page in response to the first question;
triggering modification of the first reply plan and displaying a second reply plan in the second area in response to a modification instruction for the first reply plan; and
displaying an answer obtained based on the second reply plan in the first area.

In a second aspect, the present disclosure provides an intelligent question answering apparatus based on a large model, including:
a first display module, configured to display a first question in a first area of an interaction page in response to an input instruction of a question answering task;
a second display module, configured to display a first reply plan for the first question in a second area of the interaction page in response to the first question;
a plan modification module, configured to trigger modification of the first reply plan and display a second reply plan in the second area in response to a modification instruction for the first reply plan; and
a third display module, configured to display an answer obtained based on the second reply plan in the first area.

In a third aspect, the present disclosure provides an electronic device, including: a memory and a processor, where the memory and the processor are communicatively connected to each other, the memory stores computer instructions, and the processor executes the computer instructions to perform the intelligent question answering method based on the large model according to the first aspect or any corresponding implementation thereof.

In a fourth aspect, the present disclosure provides a computer-readable storage medium having computer instructions stored thereon, where the computer instructions are used to cause a computer to perform the intelligent question answering method based on the large model according to the first aspect or any corresponding implementation thereof.

In a fifth aspect, the present disclosure provides a computer program product, including computer instructions, where the computer instructions are used to cause a computer to perform the intelligent question answering method based on the large model according to the first aspect or any corresponding implementation thereof.

According to the intelligent question answering method based on the large model provided in the embodiments of the present disclosure, a first question is displayed in a first area of an interaction page in response to an input instruction of a question answering task; a first reply plan for the first question is displayed in a second area of the interaction page in response to the first question; modification of the first reply plan is triggered and a second reply plan is displayed in the second area in response to a modification instruction for the first reply plan; and an answer obtained based on the second reply plan is displayed in the first area.

### BRIEF DESCRIPTION OF THE DRAWINGS

In order to more clearly illustrate the technical solutions in the specific implementations of the present disclosure or in the related art, the following briefly introduces the drawings that need to be used in the description of the specific implementations or related art. Obviously, the drawings in the following description are some implementations of the present disclosure, and for those of ordinary skill in the art, other drawings may be obtained based on these drawings without creative efforts.

FIG. 1 is a schematic diagram of an application scenario according to an embodiment of the present disclosure;

FIG. 2 is a first schematic flowchart of an intelligent question answering method based on a large model according to an embodiment of the present disclosure;

FIG. 3 is a first schematic diagram of a question answering page according to an embodiment of the present disclosure;

FIG. 4 is a second schematic flowchart of an intelligent question answering method based on a large model according to an embodiment of the present disclosure;

FIG. 5 is a second schematic diagram of a question answering page according to an embodiment of the present disclosure;

FIG. 6 is a third schematic diagram of a question answering page according to an embodiment of the present disclosure;

FIG. 7 is a fourth schematic diagram of a question answering page according to an embodiment of the present disclosure;

FIG. 8 is a fifth schematic diagram of a question answering page according to an embodiment of the present disclosure;

FIG. 9 is a sixth schematic diagram of a question answering page according to an embodiment of the present disclosure;

FIG. 10 is a seventh schematic diagram of a question answering page according to an embodiment of the present disclosure;

FIG. 11 is an eighth schematic diagram of a question answering page according to an embodiment of the present disclosure;

FIG. 12 is a structural block diagram of an intelligent question answering apparatus based on a large model according to an embodiment of the present disclosure; and

FIG. 13 is a schematic hardware structural diagram of an electronic device according to an embodiment of the present disclosure.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, but not all of the embodiments. Based on the embodiments in the present disclosure, all other embodiments obtained by those skilled in the art without creative efforts belong to the protection scope of the present disclosure.

It can be understood that before using the technical solutions disclosed in various embodiments of the present disclosure, users should be informed of the type, scope of use, use scenarios, etc. of personal information involved in the present disclosure in an appropriate manner and obtain the authorization of the users in accordance with relevant laws and regulations.

For example, in response to receiving an active request from a user, prompt information is sent to the user to clearly prompt the user that the requested operation will require access to and use of the user’s personal information. In this way, the user can independently choose whether to provide personal information to software or hardware, such as an electronic device, an application, a server or a storage medium, that performs the operations of the technical solutions of the present disclosure based on the prompt information.

As an optional but non-limiting implementation, in response to receiving an active request from a user, the prompt information may be sent to the user in the form of, for example, a pop-up window, and the prompt information may be presented in text in the pop-up window. In addition, the pop-up window may also carry a selection control for the user to select “agree” or “disagree” to provide personal information to the electronic device.

It can be understood that the above process of notifying and obtaining user authorization is only illustrative and does not limit the implementation of the present disclosure. Other methods that meet relevant laws and regulations can also be applied to the implementation of the present disclosure.

It can be understood that the data involved in the technical solution (including but not limited to the data itself, acquisition or use of the data) should comply with requirements of corresponding laws, regulations and related provisions.

It should be noted that the specific implementations/technical features of the embodiments of the present application can be combined arbitrarily without violating the principle of the invention.

In the related art, for a question answering task, generally, after a question is given, a thinking process for the question is displayed on an interaction page, and an answer to the question is displayed after the thinking process is completed. In this process, the thinking process is unmodifiable and only a display function is provided. If there is a problem with the thinking process, the resulting answer may not meet expectations. Therefore, it is necessary to provide an intelligent question answering method based on a large model to ensure the accuracy of the answer.

Based on this, the embodiments of the present disclosure provide an intelligent question answering method based on a large model, which provides a modification function for a reply plan after displaying the reply plan for a question. The reply plan is updated continuously by modifying the reply plan to ensure the accuracy of the reply plan, and accordingly, the accuracy of an obtained answer is improved.

As used in the embodiments of the present application, the term "model" may learn the correlation between corresponding input and output from training data, so that the corresponding output may be generated for given input after the training is completed. The generation of the model may be based on machine learning techniques, etc. Taking deep learning as an example, deep learning is a machine learning algorithm that uses multiple layers of processing units to process input and provide corresponding output. In the embodiments of the present application, the model may also be referred to as a machine learning model, a machine learning network or a network, and these terms may be used interchangeably herein. One model may include different types of processing units or networks.

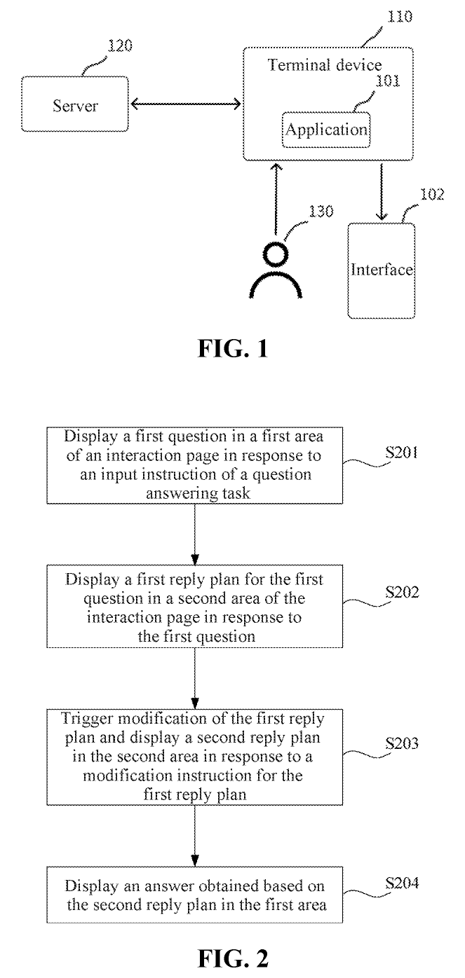

As an optional application scenario of the embodiments of the present disclosure, as shown in FIG. 1, an application 101 is installed on a terminal device 110, and a user 130 may interact with the application 101 through the terminal device 110 and/or an access device of the terminal device 110.

Exemplarily, the application 101 may be any application that may provide question answering-related services. For example, the application 101 may be a question answering interaction application, such as a text-to-text application, an image-to-text application, etc. In the application scenario shown in FIG. 1, if the application 101 is active, the terminal device 110 may present an interface 102 of the application 101. The interface 102 may include various pages that can be provided by the application 101, such as an interaction page, a settings page, a query page, etc.

In some embodiments, the terminal device 110 is communicatively connected to a server 120 to implement the supply of services for the application 101. The terminal device 110 may be a mobile terminal, a fixed terminal, a portable terminal, etc., including but not limited to a mobile phone, a desktop computer, a laptop computer, a multimedia tablet, an e-book device, a gaming device, or any combination thereof, including accessories and peripherals of these devices or any combination thereof. In some embodiments, the terminal device 110 may also support any type of interface, and the server 120 may be various types of computing systems and servers that can provide computing power, including but not limited to mainframes, edge computing nodes, computing devices in cloud environments, etc.

It should be noted that FIG. 1 is only an example of an application scenario and does not limit the protection scope of the present disclosure.

The embodiments of the present disclosure will be described below in conjunction with the drawings. It should be understood that the pages shown in the drawings are only examples, and there may actually be various page designs. Each graphic element on the page may have different arrangements and different visual representations, one or more of the elements may be omitted or replaced, and there may also be one or more other elements, which is not limited in the embodiments of the present disclosure. In addition, the embodiments are mainly described for the terminal device 110 in the following. It should be understood that the actions described with respect to the terminal device 110 may be performed by the application 101 on the terminal device 110, or may be performed by the application 101 in cooperation with its server (for example, the server 120).

According to the embodiments of the present disclosure, an embodiment of an intelligent question answering method based on a large model is provided. It should be noted that the steps shown in the flowcharts of the drawings may be executed in a computer system such as a set of computer executable instructions, and although a logical order is shown in the flowcharts, in some cases, the steps shown or described may be executed in an order different from the one presented herein.

In the present embodiment, an intelligent question answering method based on a large model is provided, which may be used for the above terminal device. FIG. 2 is a flowchart of an intelligent question answering method based on a large model according to an embodiment of the present disclosure. As shown in FIG. 2, the process includes the following steps.

Step S201, a first question is displayed in a first area of an interaction page in response to an input instruction of a question answering task.

The question answering task is used to represent that a user gives a question through interaction with the interaction page, and an intelligent system thinks according to the question and gives an answer to the question. The input instruction of the question answering task includes but is not limited to a text input instruction, a voice input instruction, a text and picture input instruction, a text and file input instruction, etc., which is specifically set according to actual needs. Correspondingly, different types of input instructions correspond to different input methods. Taking the voice input instruction as an example, a voice interaction control is displayed on the interaction page, and the voice input instruction is acquired through interaction with the voice interaction control.

The interaction page is used to represent a page provided by a question answering application, and the first question is displayed in the first area of the interaction page. The first question is a question obtained in response to the input instruction of the question answering task. Corresponding to the input instruction described above, the first question includes but is not limited to text, text and pictures, text and files, etc. For example, the first question includes only a question description, or includes a picture and a question description, or includes a file and a question description, etc.

The interaction page may be divided into areas according to the functions of the page, and the number of divisions is not limited here. Correspondingly, the first area may be located in any area of the interaction page, which may be specifically set according to actual needs.

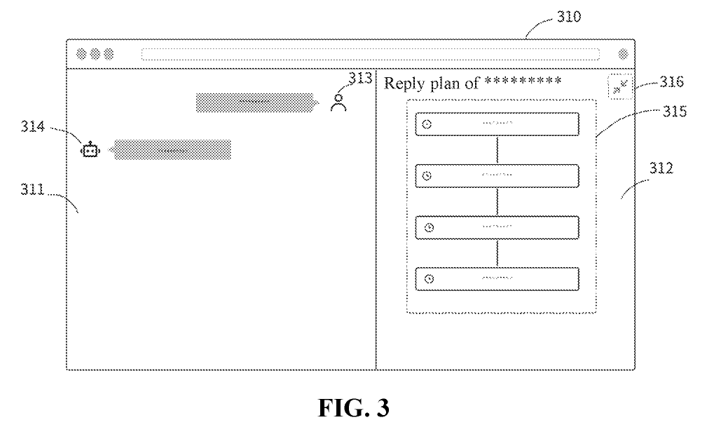

For example, FIG. 3 shows a first schematic diagram of an interaction page 310. A conversation between a user 313 and an intelligent system 314 is displayed in a first area 311 of the interaction page 310. The identifier of the user 313 and the identifier of the intelligent system 314 are also shown in FIG. 3. The identifier may be represented by an image, text, etc., which is not limited here.

Step S202, a first reply plan for the first question is displayed in a second area of the interaction page in response to the first question.

After the first question is given, the terminal device displays a thinking process for the first question, that is, the first reply plan, in the second area of the interaction page in response to the first question. The area where the second area is located on the interaction page is set according to actual needs, which is not limited here.

The first reply plan includes a plan outline and specific implementation methods of various parts in the plan outline. For example, the plan outline includes five steps, and each step includes a specific implementation method of this step.

For example, as shown in FIG. 3, a first reply plan 315 is displayed in a second area 312 of the interaction page 310. The first reply plan 315 includes four steps, and the specific implementation of each step may be expanded to display the specific implementation through interaction with the corresponding step; or, it may also be expanded to display the specific implementation during the execution of each step, etc. The display manner of the specific implementation of each step is not limited here, and it may be specifically set according to actual needs.

Step S203, modification of the first reply plan is triggered and a second reply plan is displayed in the second area in response to a modification instruction for the first reply plan.

The first reply plan in the interaction page also provides a modification function, and the plan outline of the first reply plan may be modified, or the specific implementation of each step in the plan outline may be modified.

The modification manner for the first reply plan may be editing the text of the first reply plan, commenting on the corresponding content of the first reply plan, or modifying the logic diagram of the first reply plan by means of a canvas, etc. Certainly, other manners may also be used to modify the first reply plan, and the modification manner of the first reply plan is not limited here, and it may be specifically set according to actual needs.

After the first reply plan is modified, the second reply plan is obtained. It should be noted that the second reply plan is not specifically a reply plan obtained after modifying the first reply plan once, but generally refers to a second reply plan that is finally determined by modifying the first reply plan. The first reply plan may be modified once, twice or multiple times here. It should be understood that the described two modifications to the first reply plan may be modifications based on the reply plan after the first modification to the first reply plan, that is, each modification may be based on the previous modification, or may be selected to be based on any previous modification. The modification basis for each modification is not limited here.

The second reply plan obtained after the modification of the first reply plan is displayed in the second area 312 of the interaction page 310. The second area 312 may always be displayed on the interaction page 310, or may be hidden by interacting with an interactive control 316. The display style of the interactive control 316 is not limited to that shown in FIG. 3, and there may be other display styles, which is not limited here. The hidden display of the second area 312 may be folded into a floating control with a preset size in the interaction page 310, and the display of the second area 312 may be expanded through interaction with the floating control; or, the hidden display of the second area 312 may represent that it is not displayed in the interaction page 310, and the display of the second area 312 is expanded through interaction of corresponding function controls in the interaction page 310. The hiding and displaying manner of the second area 312 is not limited here, and it may be specifically set according to actual needs.

Step S204, an answer obtained based on the second reply plan is displayed in the first area.

After the second reply plan is determined, thinking may be performed according to the thinking process given by the second reply plan to obtain the corresponding answer, and the obtained answer is displayed in the first area.

The answer may be displayed in a text, a table, a slide, a document in other formats, etc., which may be specifically displayed according to actual needs and is not limited here.

According to the intelligent question answering method based on the large model provided in the present embodiment, after the first question that needs to be answered is obtained, the first reply plan for the first question is generated and displayed first, and the first reply plan is used to represent the thinking step for the first question. After the first reply plan is displayed, the modification function for the first reply plan is further provided, and the first reply plan is modified in an interactive manner to obtain the second reply plan, so that the accuracy of the thinking process for the first question can be ensured, and the accuracy of the answer obtained based on the second reply plan can be ensured.

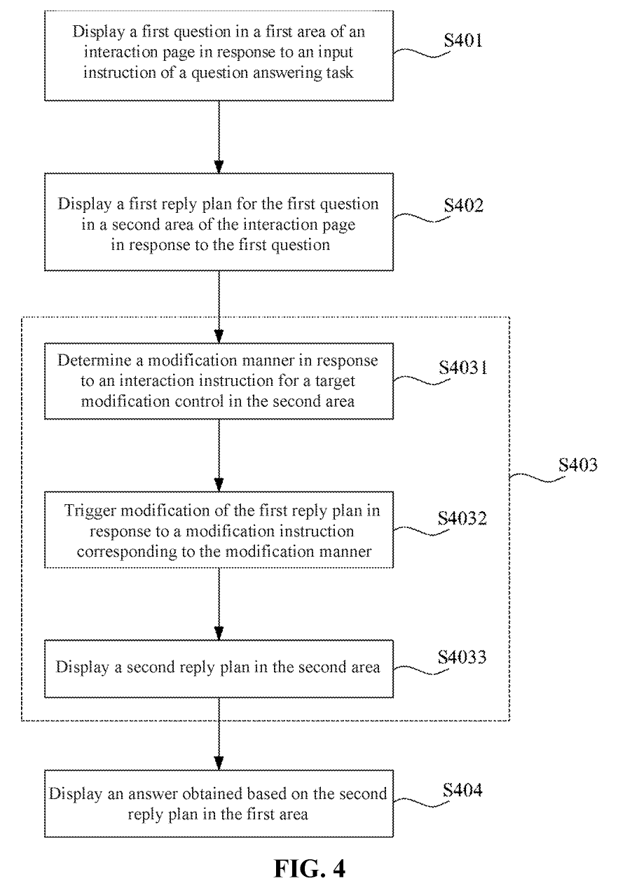

In the present embodiment, an intelligent question answering method based on a large model is provided, which may be used for the above terminal device. FIG. 4 is a flowchart of an intelligent question answering method based on a large model according to an embodiment of the present disclosure. As shown in FIG. 4, the process includes the following steps.

Step S401, a first question is displayed in a first area of an interaction page in response to an input instruction of a question answering task. For details, see step S201 of the embodiment shown in FIG. 2, which is not limited here.

Step S402, a first reply plan for the first question is displayed in a second area of the interaction page in response to the first question. For details, see step S202 of the embodiment shown in FIG. 2, which is not limited here.

Step S403, modification of the first reply plan is triggered and a second reply plan is displayed in the second area in response to a modification instruction for the first reply plan.

Exemplarily, the above step S403 includes:
Step S4031, a modification manner is determined in response to an interaction instruction for a target modification control in the second area.

The target modification control is displayed in the second area, and different target modification controls are used to represent different modification manners. Different target modification controls are represented by corresponding identifiers, and the specific style corresponds to the modification manner.

The target modification control may be used as a sub-control under the modification control. For example, the modification control is displayed in the second area, and the sub-control is displayed through interaction with the modification control. The sub-control is in one-to-one correspondence with the modification manner. Certainly, other manners may also be used to display the target modification control in the second area, which is not limited here, and it may be specifically set according to actual needs.

After interacting with the target modification control, the modification manner is determined accordingly. After the modification manner is determined, the second area may display a style corresponding to the modification manner to ensure that the modification operation can be performed.

For example, as shown in FIG. 5, a modification control 501 is displayed in the second area of the interaction page, and the modification control 501 includes sub-controls in one-to-one correspondence with modification manners, that is, the target modification controls described above.

Step S4032, modification of the first reply plan is triggered in response to a modification instruction corresponding to the modification manner.

After the modification manner is determined, interaction is performed with the first reply plan based on the modification manner, the modification instruction is generated, and the modification of the first reply plan is triggered by the modification instruction. For example, comments on the first reply plan, or logic adjustment of the first reply plan, etc.

In some optional implementations, the above step S4032 includes:
Step a1, if the modification manner is a comment manner, comment content is displayed at a corresponding position of first plan content in the first reply plan in response to a comment instruction for the first plan content.
Step a2, modification of the first reply plan is triggered in response to an instruction for re-generating the plan.

If the determined modification manner is the comment manner, the comment on the first plan content is realized through interaction with the first plan content in the first reply plan, the comment instruction for the first plan content is generated, and the comment content is displayed at the corresponding position of the first plan content accordingly. The comment content is used to indicate a modification manner for the first plan content.

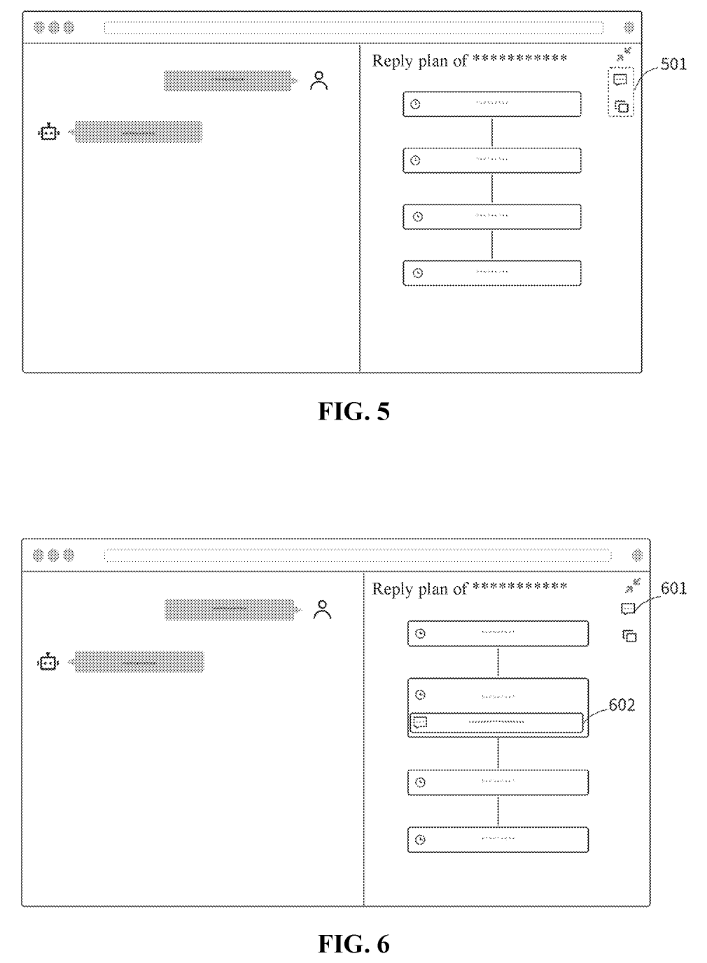

For example, as shown in FIG. 6, if the selected target modification control is a comment control 601, the modification to the first reply plan is given in the form of comments. In FIG. 6, comment content 602 for the first plan content is given, and the first plan content that the comment content is directed to may be determined according to the position of the comment content 602. Specifically, in FIG. 6, the comment content 602 is located at the position of the second step in the first reply plan, which represents that the comment content 602 is a modification description given for the second step.

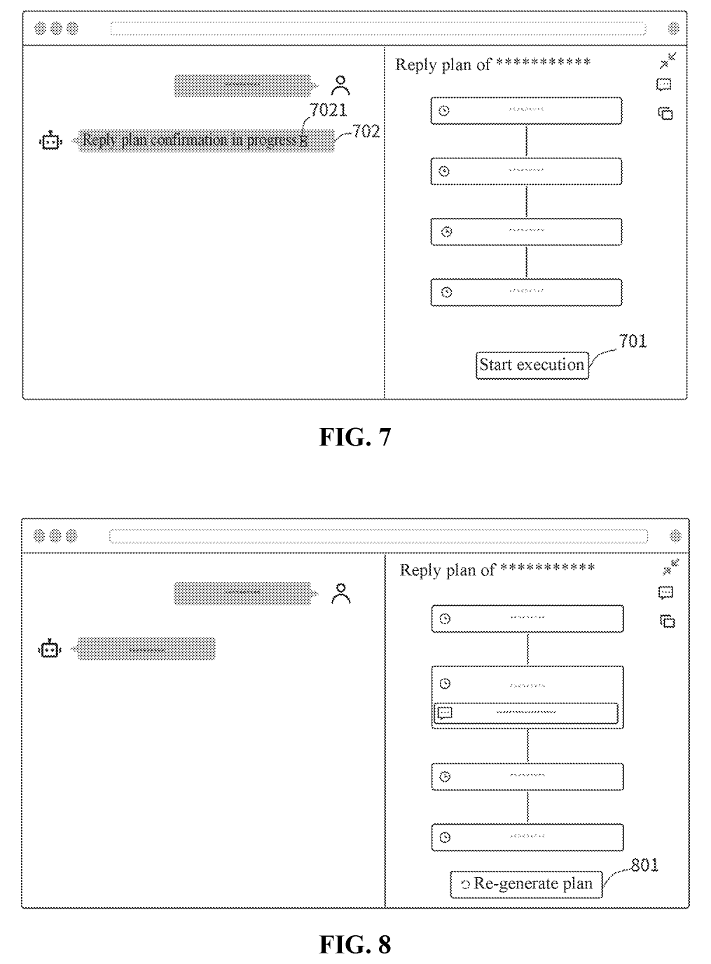

After the first reply plan is generated, the execution state of the reply plan is displayed in the first area. Exemplarily, as shown in FIG. 7, "Reply plan confirmation in progress" is displayed in reply information given by the intelligent system, which is used to represent that the first reply plan is waiting for confirmation. The confirmation of the first reply plan may be realized through interaction with a start execution control 701 displayed in the second area, or timing may be started after the first reply plan is generated, which is used to count the continuous modification-free duration of the first reply plan. If the duration reaches a preset duration, it represents that the first reply plan is confirmed, and processing for the first reply plan is started. For example, the prompt information 702 given by the intelligent system includes a text description of "Reply plan confirmation in progress" and a timer 7021, and the timer 7021 is used to trigger timing after the first reply plan is generated. If there is a modification to the first reply plan, the timing is stopped and the timing result is cleared, and the timing may be restarted after the modification. If the timing reaches the preset duration, the execution of the modified reply plan is actively triggered.

After the first reply plan is modified, as shown in FIG. 8, the interaction with a plan re-generation control 801 in the second area may be used to trigger the modification of the first reply plan, and accordingly, the modification result is displayed in the second area. It should be noted that the plan re-generation may be triggered by the plan re-generation control 801 shown in FIG. 8, by a shortcut key, or by other manners, which is not limited here, and may be specifically set according to actual needs.

If the modification manner is the comment manner, comments may be made on the first plan content in the first reply plan, and the comment content is displayed at the corresponding position. The comment content is used to indicate the modification to the first plan content, and accordingly, the modification of the first reply plan is triggered by giving the instruction for re-generating the plan.

In some optional implementations, the above step S4032 includes:
Step b1, if the modification manner is a canvas manner, the first reply plan is displayed in a canvas form.
Step b2, the modified first reply plan is displayed in response to the modification instruction for the first reply plan in the canvas.
Step b3, the modified first reply plan is triggered to take effect in response to the instruction for re-generating the plan.

If the determined modification manner is the canvas manner, the first reply plan is displayed in the canvas form. In the canvas, the modification to the first reply plan is realized through the interaction with the first reply plan, the modification instruction is generated, and the modified first reply plan is displayed accordingly. The re-generation of the reply plan is triggered by the interaction with the plan re-generation control, by a shortcut key or by other manners, the instruction for re-generating the plan is generated, and then the modified first reply plan is triggered to take effect.

The first reply plan is modified by the modification manner of the canvas, so that the processing logic of the first reply plan can be flexibly adjusted, and the operation is flexible and simple.

Step S4033, the second reply plan is displayed in the second area.

After one or more modifications to the first reply plan, a determined reply plan is finally obtained, which is referred to as the second reply plan. Accordingly, the determined second reply plan is displayed in the second area. For the description of the second reply plan, see the description of the embodiment shown in FIG. 2 above, which will not be repeated here.

Step S404, an answer obtained based on the second reply plan is displayed in the first area. For details, see the description of step S204 of the embodiment shown in FIG. 2, which will not be repeated here.

According to the intelligent question answering method based on the large model provided in the present embodiment, the target modification control for the reply plan is displayed in the second area, the modification manner is determined through the interaction with the target modification control, and the modification of the first reply plan is triggered according to the corresponding modification manner, that is, multiple modification manners may be provided to meet modification requirements in different scenarios.

In some optional implementations, the above intelligent question answering method based on the large model further includes:
Step c1, the complexity of the first question is acquired.
Step c2, if the complexity represents that the first question needs to be replied on the basis of plan generation, the step of displaying the first reply plan for the first question in the second area of the interaction page in response to the first question is performed.
Step c3, if the complexity represents that the first question may be directly replied, the answer to the first question is displayed in the first area.

After the first question is given, the complexity is obtained by performing semantic analysis on the first question. The complexity may be represented by a probability value, corresponding text, etc. The display form of the complexity is not limited here, and it may be specifically set according to actual needs. For example, after the first question is acquired, semantic analysis is performed on the first question by a language model, and the complexity of the first question is output.

The complexity represents the degree of difficulty in replying to the first question. If the value of the complexity is relatively large, it represents that the first question needs to be replied on the basis of plan generation, and step S202 of the embodiment shown in FIG. 2 or step S402 of the embodiment shown in FIG. 4 is performed. If the value of the complexity is relatively small, it represents that the first question may be directly replied without generating a reply plan, and the answer to the first question is displayed in the first area. The value of the complexity being relatively large or relatively small may be determined by comparing the value of the complexity with a preset threshold. If the value of the complexity is greater than the preset threshold, it represents that the value of the complexity is relatively large; otherwise, it represents that the value of the complexity is relatively small.

Whether a reply plan needs to be generated is determined according to the complexity of the first question, the first reply plan is generated for a complex first question, and the answer to the first question is directly displayed for a non-complex question, thus improving the question answering efficiency.

In some optional implementations, the above intelligent question answering method based on the large model further includes:
Step d1, a first plan version number of the first reply plan is recorded.
Step d2, after the first reply plan is modified, a second plan version number of the second reply plan is recorded to obtain the first plan version number and the second plan version number corresponding to the first question.

The version number of the first reply plan generated for the first time is V1, and each time the reply plan is modified subsequently, the version number is recorded once, for example, in an incremental manner such as V2, V3, ... Vn. Specifically, the first reply plan corresponds to the first plan version number, and the second reply plan corresponds to the second plan version number. Each time the reply plan is modified, a corresponding plan version number may be obtained, and the plan version number is used as a unique identifier of the reply plan.

For the given first question, a reply plan and a plan version number of a corresponding version are obtained according to the number of modifications to the reply plan. It should be noted that "after the reply plan is modified" represented here represents that the modification of the reply plan is effective, and if the modification of the reply plan is invalid, there is no need to record the version number. For example, the described effective modification of the reply plan may be triggered by re-generating the reply plan after the modification.

For the same question, a corresponding plan version number is generated for each modification to the reply plan, that is, different reply plans are distinguished by the plan version number, which is convenient for viewing the corresponding reply plan subsequently.

In some optional implementations, the above intelligent question answering method based on the large model further includes:
Step e1, a plan version number selection control is displayed in the second area in response to a selection instruction for plan described in the first area.
Step e2, a target plan version number is determined in response to an interaction instruction for the plan version number selection control in the second area.
Step e3, an answer obtained based on a reply plan corresponding to the target plan version number is displayed in the first area.

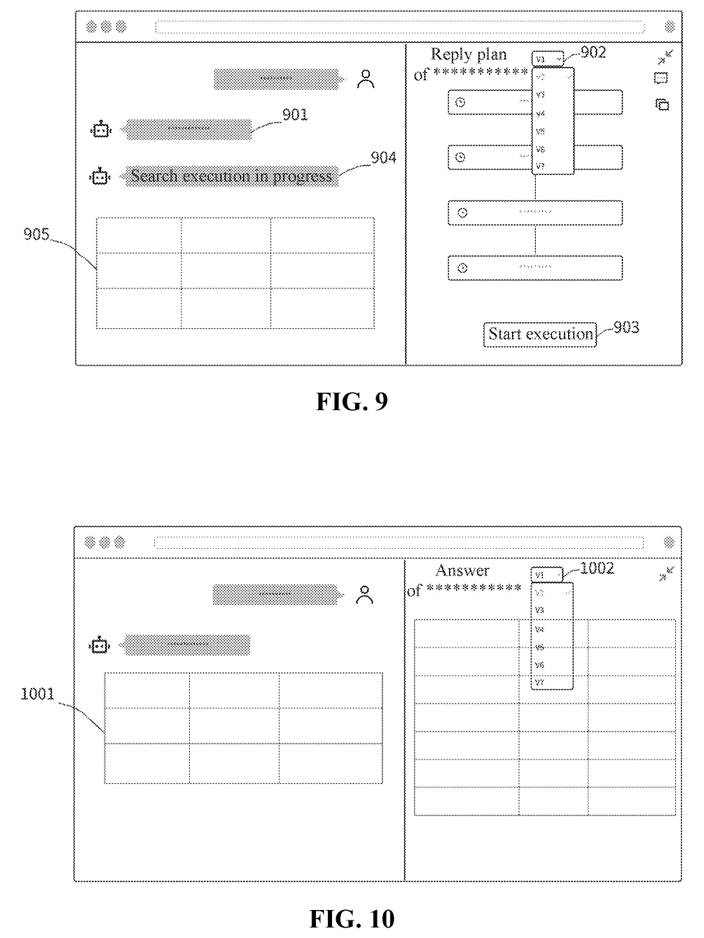

A question answering pair is displayed in the first area, that is, a reply given by the intelligent system to the question given by the user. As described above, the intelligent system also gives the description of the execution state of the reply plan. For example, as shown in FIG. 9, a reply 901 of the intelligent system and an execution state 904 of the reply plan are displayed in the first area. After the reply plan is completed, the answer 905 to the first question is displayed in the first area.

Therefore, the plan description and the answer for the reply plan are both displayed in the first area, and the plan version number selection control is displayed in the second area through interaction with the plan description. For example, through interaction with the plan version number selection control 902 shown in FIG. 9, the display of the plan version number for the first question is triggered, and the target plan version number to be selected is determined through the interaction instruction for the plan version number selection control.

After the target plan version number is determined, it represents that the answer to the reply plan corresponding to the target plan version number is desired to be obtained at this time. Therefore, after the target plan version number is selected, the execution of the reply plan corresponding to the target plan version number may be directly triggered to obtain the answer; or after the target plan version number is selected, the execution of the corresponding reply plan may be triggered by interacting with the start execution control 903 shown in FIG. 9 to obtain the answer, etc. The manner is not limited here, and it may be specifically set according to actual needs.

For example, as shown in FIG. 9, if the selected target plan version number is V2, the reply plan of the V2 version may be directly executed, and the answer obtained by executing the reply plan is displayed in the first area.

The answer to the reply plan of the target plan version number that currently needs to be viewed is determined by selecting the plan version number, which is convenient for comparing answers of different reply plans.

In some optional implementations, the above intelligent question answering method based on the large model further includes:
Step f1, detailed answer information is displayed in the second area in response to a selection instruction for the answer obtained based on the second reply plan.
Step f2, detailed information of an answer corresponding to a first answer version number is displayed in the second area in response to a selection instruction for the first answer version number in the second area, where the answer version number corresponds to the reply plan.

As described above, for the same question, corresponding answers may be obtained from reply plans corresponding to different reply plan version numbers. Therefore, in order to obtain answers of different versions of reply plans, the answers obtained from each reply plan are distinguished in the form of version numbers. That is, the same question corresponds to one or more reply version numbers, and each reply version number corresponds to one answer.

When the answer is displayed in the first area, only the brief content of the answer may be displayed, or the detailed content of the answer may be displayed. The detailed information of the answer is correspondingly displayed in the second area through the selection instruction for the corresponding answer in the first area.

Further, an answer version number is also displayed in the second area. Specifically, the first answer version number that needs to be displayed is determined through the selection instruction for the first answer version number in the second area, and accordingly, the detailed information of the answer corresponding to the first answer version number is displayed in the second area. For example, as shown in FIG. 10, the answer 1001 to the first question is displayed in the first area, the answer version number selection control 1002 is displayed in the second area through interaction with the answer 1001, and the first answer version number is selected through interaction with the answer version number selection control 1002. Accordingly, the answer corresponding to the first answer version number is displayed in the second area. That is, by setting the answer version number, the review of historical answers to the same question may be realized.

Corresponding answer version numbers are recorded for answers to the same question under different reply plans, and the viewing of different answers is realized by supporting the switching of answer version numbers.

In some optional implementations, the above intelligent question answering method based on the large model further includes:
Step g1, prompt information for plan confirmation is displayed in the first area before an instruction for starting plan execution is received.
Step g2, if the instruction for starting plan execution is received, prompt information for plan execution in progress is displayed in the first area.

As described above, the description of the execution state of the reply plan is displayed in the first area of the interaction page. Specifically, before the instruction for starting plan execution is received, the execution state of the reply plan is plan confirmation in progress, and accordingly, the prompt information for plan confirmation is displayed in the first area; if the instruction for starting plan execution is received, the execution state of the reply plan is plan execution in progress, and accordingly, the prompt information for plan execution in progress is displayed in the first area.

The linkage display of the first area and the second area is convenient for intuitively perceiving the current execution state.

In some optional implementations, the above intelligent question answering method based on the large model further includes:
Step h1, a resource library is displayed in a third area of the interaction page, where the resource library includes file resources.
Step h2, an identifier of a target file resource is displayed in the first area in response to a selection instruction for the file resources, where the target file resource is used to assist in answering the first question.

A resource library is also displayed in a third area of the interaction page, and the resource library includes file resources. That is, the resource library may also be immediately used as a personal knowledge space, which belongs to a private knowledge space. Before instructing the intelligent system to reply to the first question, the file resource may be selected first through interaction with the resource library, to obtain a target file identifier. The target file represents knowledge for replying to the first question.

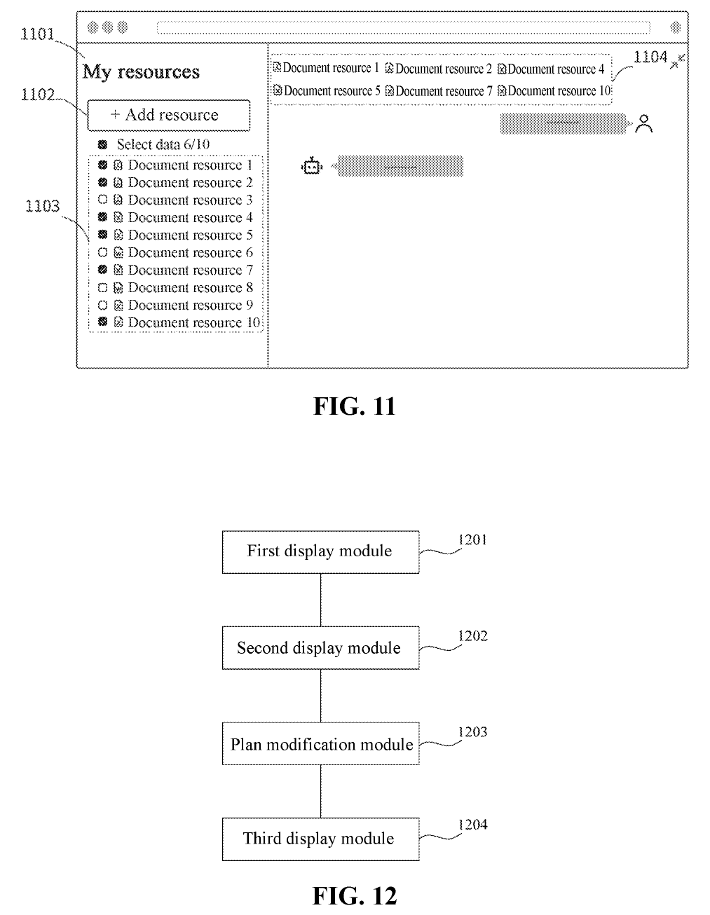

For example, as shown in FIG. 11, a resource library 1101 is displayed in the third area, and a file resource 1103 is selected through interaction with the resource library, to determine a target file resource. Accordingly, an identifier 1104 of the target file resource is displayed in the first area.

An add resource control 1102 is also displayed in the third area. If the file resources in the resource library cannot meet the requirements for question reply, the addition of the file resource is triggered through interaction with the add resource control 1102. The source of the file resource may be a local file resource, a collected file resource, etc. The source of the file resource is not limited here.

After the target file resource is given, the intelligent system obtains the answer to the first question by combining the target file resource and public domain resources.

When performing the question answering task, the file resource in the resource library is provided to assist in answering the first question, so that the obtained answer can meet the requirements of the current scenario.

As a specific application embodiment of the embodiments of the present disclosure, with reference to the contents shown in FIGS. 1-11, the running of the interactive application is triggered, and the interaction page is displayed. In the resource library 1101 in the third area of the interaction page, the target file resource is determined through interaction with the file resource 1103 in the resource library 1101, and accordingly, the identifier 1104 of the target file resource is displayed in the first area. The user gives the first question through interaction with the first area of the interaction page, and accordingly, the first reply plan 315 is displayed in the second area 312. The second reply plan is determined and displayed through comments on the first reply plan 315 and triggering the re-generation of the reply plan. In this process, the intelligent system gives the execution state of the reply plan, for example, reply state confirmation in progress. By triggering the execution of the second reply plan, the intelligent system gives the execution state of the reply plan, for example, state execution in progress. After the reply plan is completed, the corresponding answer is displayed in the first area of the interaction page.

The reply plan for the same question has a corresponding reply plan version number, and each reply plan has a corresponding answer version number. The corresponding reply plan is viewed through interactive selection of the reply plan version number, and the answer corresponding to the reply plan may be displayed; the corresponding answer is viewed through interactive selection of the answer version number.

In the present embodiment, an intelligent question answering apparatus based on a large model is further provided. The apparatus is used to implement the above embodiments and preferred implementations, which will not be repeated here. As used below, the term "module" may implement a combination of software and/or hardware for a predetermined function. Although the apparatus described in the following embodiments is preferably implemented in software, implementation in hardware, or a combination of software and hardware is also possible and contemplated.

The present embodiment provides an intelligent question answering apparatus based on a large model, which, as shown in FIG. 12, includes:
a first display module 1201, configured to display a first question in a first area of an interaction page in response to an input instruction of a question answering task.
The second display module 1202 is configured to display a first reply plan for the first question in a second area of the interaction page in response to the first question.
The plan modification module 1203 is configured to trigger modification of the first reply plan and display a second reply plan in the second area in response to a modification instruction for the first reply plan.
The third display module 1204 is configured to display an answer obtained based on the second reply plan in the first area.

In some optional implementations, the plan modification module 1203 includes:
a first response unit, configured to determine a modification manner in response to an interaction instruction for a target modification control in the second area;
a second response unit, configured to trigger modification of the first reply plan in response to a modification instruction corresponding to the modification manner; and
a first display unit, configured to display the second reply plan in the second area.

In some optional implementations, the second response unit includes:
a first response subunit, configured to: if the modification manner is a comment manner, display comment content at a corresponding position of first plan content in the first reply plan in response to a comment instruction for the first plan content; and
a second response subunit, configured to trigger modification of the first reply plan in response to an instruction for re-generating the plan.

In some optional implementations, the second response unit includes:
a first display subunit, configured to: if the modification manner is a canvas manner, display the first reply plan in a canvas form;
a second display subunit, configured to display the modified first reply plan in response to the modification instruction for the first reply plan in the canvas; and
a third response subunit, configured to trigger the modified first reply plan to take effect in response to the instruction for re-generating the plan.

In some optional implementations, the apparatus further includes:
a complexity acquisition module, configured to acquire the complexity of the first question;
a first execution module, configured to: if the complexity represents that the first question needs to be replied on the basis of plan generation, perform the step of displaying the first reply plan for the first question in the second area of the interaction page in response to the first question; and
a second execution module, configured to: if the complexity represents that the first question may be directly replied, display the answer to the first question in the first area.

In some optional implementations, the apparatus further includes:
a first recording module, configured to record a first plan version number of the first reply plan; and
a second recording module, configured to: after the first reply plan is modified, record a second plan version number of the second reply plan to obtain the first plan version number and the second plan version number corresponding to the first question.

In some optional implementations, the apparatus further includes:
a first response module, configured to display a plan version number selection control in the second area in response to a selection instruction for plan description in the first area;
The second response module is configured to determine a target plan version number in response to an interaction instruction for the plan version number selection control in the second area.
The fourth display module is configured to display, in the first area, an answer obtained based on a reply plan corresponding to the target plan version number.

In some optional implementations, the apparatus further includes:
a third response module, configured to display detailed answer information in the second area in response to a selection instruction for the answer obtained based on the second reply plan; and
a fourth response module, configured to display, in the second area, detailed information of an answer corresponding to a first answer version number in response to a selection instruction for the first answer version number in the second area, where the answer version number corresponds to the reply plan.

In some optional implementations, the apparatus further includes:
a first prompt module, configured to display, in the first area, prompt information for plan confirmation before an instruction for starting plan execution is received; and
a second prompt module, configured to: if the instruction for starting plan execution is received, display, in the first area, prompt information for plan execution in progress.

In some optional implementations, the apparatus further includes:
a fifth display module, configured to display a resource library in a third area of the interaction page, where the resource library includes file resources; and
a fifth response module, configured to display, in the first area, an identifier of a target file resource in response to a selection instruction for the file resources, where the target file resource is used to assist in answering the first question.

The intelligent question answering apparatus based on the large model provided in the embodiments of the present disclosure may perform the intelligent question answering method based on the large model provided in any embodiment of the present disclosure, and has corresponding functional modules and beneficial effects for performing the method. After obtaining the first question that needs to be answered, the apparatus first generates and displays the first reply plan for the first question, and the first reply plan is used to represent the thinking step for the first question. After displaying the first reply plan, the apparatus further provides the modification function for the first reply plan, and modifies the first reply plan in an interactive manner to obtain the second reply plan, so that the accuracy of the thinking process for the first question can be ensured, and the accuracy of the answer obtained based on the second reply plan can be ensured. Further functional descriptions of the above modules and units are the same as the corresponding embodiments above, and will not be repeated here.

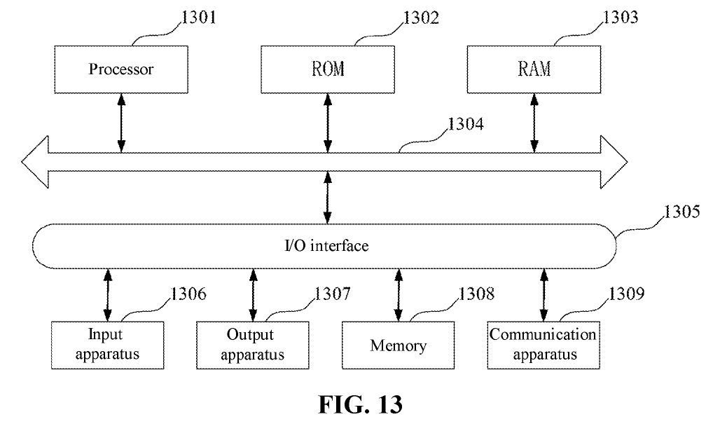

FIG. 13 is a schematic structural diagram of an electronic device provided in an embodiment of the present disclosure.

Reference is made specifically to FIG. 13 below, which shows a schematic structural diagram of an electronic device suitable for implementing the embodiments of the present disclosure. The electronic device may include a processor (such as a central processing unit, a graphics processing unit, etc.) 1301, which may perform various appropriate actions and processes according to a program stored in a read-only memory (ROM) 1302 or a program loaded from a memory 1308 into a random access memory (RAM) 1303. The RAM 1303 further stores various programs and data required for the operation of the electronic device. The processor 1301, the ROM 1302, and the RAM 1303 are connected to each other through a bus 1304. An input/output (I/O) interface 1305 is also connected to the bus 1304.

Usually, the following apparatuses may be connected to the I/O interface 1305: an input apparatus 1306 including, for example, a touch screen, a touchpad, a keyboard, a mouse, a camera, a microphone, an accelerometer, a gyroscope, etc.; an output apparatus 1307 including, for example, a liquid crystal display (LCD), a speaker, a vibrator, etc.; a memory 1308 including, for example, a magnetic tape, a hard disk, etc.; and a communication apparatus 1309. The communication apparatus 1309 may allow the electronic device to perform wireless or wired communication with other devices to exchange data. Although FIG. 13 shows an electronic device having various apparatuses, it should be understood that it is not required to implement or have all of the shown apparatuses, and alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for executing the method shown in the flowchart. In such an embodiment, the computer program may be downloaded and installed from a network through the communication apparatus 1309, or installed from the memory 1308, or installed from the ROM 1302. When the computer program is executed by the processor 1301, the above functions defined in the intelligent question answering method based on the large model in the embodiments of the present disclosure are executed.

The electronic device shown in FIG. 13 is only an example, and should not impose any limitation on the functions and scope of use of the embodiments of the present disclosure.

The embodiments of the present disclosure further provide a computer-readable storage medium. The method according to the embodiments of the present disclosure described above may be implemented in hardware and firmware, or implemented as computer code that may be recorded on a storage medium or originally stored in a remote storage medium or a non-transitory machine-readable storage medium and downloaded through a network and to be stored in a local storage medium, so that the method described herein may be performed by software stored on the storage medium using a general-purpose computer, a dedicated processor, or programmable or dedicated hardware. The storage medium may be a magnetic disk, an optical disk, a read-only memory, a random access memory, a flash memory, a hard disk or a solid-state disk, etc. Further, the storage medium may also include a combination of the above types of memories. It can be understood that the computer, the processor, the microprocessor controller or the programmable hardware includes a storage component that can store or receive software or computer code, and when the software or computer code is accessed and executed by the computer, the processor or the hardware, the intelligent question answering method based on the large model shown in the above embodiments is implemented.

A portion of the present disclosure may be applied as a computer program product, such as computer program instructions, which, when executed by a computer, may invoke or provide the method and/or technical solutions according to the present disclosure through the operation of the computer. Those skilled in the art should be able to understand that the form of existence of computer program instructions in a computer-readable medium includes, but is not limited to, source files, executable files, installation package files, etc. Accordingly, the manner in which the computer program instructions are executed by the computer includes, but is not limited to, the following: the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium that may be accessed by the computer.

Although the embodiments of the present disclosure have been described in conjunction with the drawings, those skilled in the art may make various modifications and variations without departing from the spirit and scope of the present disclosure, and such modifications and variations fall within the scope defined by the appended claims.

I/We claim:

1. An intelligent question answering method based on a large model, comprising:
displaying a first question in a first area of an interaction page in response to an input instruction of a question answering task;
displaying a first reply plan for the first question in a second area of the interaction page in response to the first question;
triggering modification of the first reply plan and displaying a second reply plan in the second area in response to a modification instruction for the first reply plan; and
displaying an answer obtained based on the second reply plan in the first area.

2. The method of claim 1, wherein triggering the modification of the first reply plan and displaying the second reply plan in the second area in response to the modification instruction for the first reply plan comprises:
determining a modification manner in response to an interaction instruction for a target modification control in the second area;
triggering the modification of the first reply plan in response to a modification instruction corresponding to the modification manner; and
displaying the second reply plan in the second area.

3. The method of claim 2, wherein triggering the modification of the first reply plan in response to the modification instruction corresponding to the modification manner comprises:
displaying, in response to the modification manner being a comment manner, comment content at a corresponding position of first plan content in the first reply plan in response to a comment instruction for the first plan content; and
triggering the modification of the first reply plan in response to an instruction for re-generating a plan.

4. The method of claim 2, wherein triggering the modification of the first reply plan in response to the modification instruction corresponding to the modification manner comprises:
displaying, in response to the modification manner being a canvas manner, the first reply plan in a canvas form;
displaying the modified first reply plan in response to the modification instruction for the first reply plan in the canvas; and
triggering the modified first reply plan to take effect in response to the instruction for re-generating a plan.

5. The method of claim 1, further comprising:
acquiring complexity of the first question;
performing, in response to the complexity representing that the first question needs to be replied on the basis of plan generation, the step of displaying the first reply plan for the first question in the second area of the interaction page in response to the first question; and
displaying, in response to the complexity representing that the first question can be directly replied, the answer to the first question in the first area.

6. The method of claim 1, further comprising:
recording a first plan version number of the first reply plan; and
recording, after the first reply plan is modified, a second plan version number of the second reply plan to obtain the first plan version number and the second plan version number corresponding to the first question.

7. The method of claim 1, further comprising:
displaying a plan version number selection control in the second area in response to a selection instruction for plan description in the first area;
determining a target plan version number in response to an interaction instruction for the plan version number selection control in the second area; and
displaying, in the first area, an answer obtained based on a reply plan corresponding to the target plan version number.

8. The method of claim 1, further comprising:
displaying detailed answer information in the second area in response to a selection instruction for the answer obtained based on the second reply plan; and
displaying, in the second area, detailed information of an answer corresponding to a first answer version number in response to a selection instruction for the first answer version number in the second area, wherein an answer version number corresponds to a reply plan.

9. The method of claim 1, further comprising:
displaying, in the first area, prompt information for plan confirmation before an instruction for starting plan execution is received; and
displaying, in response to receiving the instruction for starting plan execution, in the first area, prompt information for plan execution in progress.

10. The method of claim 1, further comprising:
displaying a resource library in a third area of the interaction page, wherein the resource library comprises file resources; and
displaying, in the first area, an identifier of a target file resource in response to a selection instruction for the file resources, wherein the target file resource is used to assist in answering the first question.

11. An electronic device, comprising:
a memory and a processor, wherein the memory and the processor are communicatively connected to each other, the memory stores computer instructions, and the processor executes the computer instructions, causing the device to:
display a first question in a first area of an interaction page in response to an input instruction of a question answering task;
display a first reply plan for the first question in a second area of the interaction page in response to the first question;
trigger modification of the first reply plan and display a second reply plan in the second area in response to a modification instruction for the first reply plan; and
display an answer obtained based on the second reply plan in the first area.

12. The electronic device according to claim 11, wherein the processor triggering the modification of the first reply plan and displaying the second reply plan in the second area in response to the modification instruction for the first reply plan further causes the device to:
determine a modification manner in response to an interaction instruction for a target modification control in the second area;
trigger the modification of the first reply plan in response to a modification instruction corresponding to the modification manner; and
display the second reply plan in the second area.

13. The electronic device according to claim 12, wherein the processor triggering the modification of the first reply plan in response to the modification instruction corresponding to the modification manner further causes the device to:
display, in response to the modification manner being a comment manner, comment content at a corresponding position of first plan content in the first reply plan in response to a comment instruction for the first plan content; and
trigger the modification of the first reply plan in response to an instruction for re-generating a plan.

14. The electronic device according to claim 12, wherein the processor triggering the modification of the first reply plan in response to the modification instruction corresponding to the modification manner further causes the device to:
display, in response to the modification manner being a canvas manner, the first reply plan in a canvas form;
display the modified first reply plan in response to the modification instruction for the first reply plan in the canvas; and
trigger the modified first reply plan to take effect in response to the instruction for re-generating a plan.

15. The electronic device according to claim 11, wherein the processor further causes the device to:
acquire complexity of the first question;
perform, in response to the complexity representing that the first question needs to be replied on the basis of plan generation, the step of displaying the first reply plan for the first question in the second area of the interaction page in response to the first question; and
display, in response to the complexity representing that the first question can be directly replied, the answer to the first question in the first area.

16. The electronic device according to claim 11, wherein the processor further causes the device to:
record a first plan version number of the first reply plan; and
record, after the first reply plan is modified, a second plan version number of the second reply plan to obtain the first plan version number and the second plan version number corresponding to the first question.

17. The electronic device according to claim 11, wherein the processor further causes the device to:
display a plan version number selection control in the second area in response to a selection instruction for plan description in the first area;
determine a target plan version number in response to an interaction instruction for the plan version number selection control in the second area; and
display, in the first area, an answer obtained based on a reply plan corresponding to the target plan version number.

18. The electronic device according to claim 11, wherein the processor further causes the device to:
display detailed answer information in the second area in response to a selection instruction for the answer obtained based on the second reply plan; and
display, in the second area, detailed information of an answer corresponding to a first answer version number in response to a selection instruction for the first answer version number in the second area, wherein an answer version number corresponds to a reply plan.

19. The electronic device according to claim 11, wherein the processor further causes the device to:
display, in the first area, prompt information for plan confirmation before an instruction for starting plan execution is received; and
display, in response to receiving the instruction for starting plan execution, in the first area, prompt information for plan execution in progress.

20. A non-transitory computer-readable storage medium having computer instructions stored thereon, wherein the computer instructions are used to cause a computer to:
display a first question in a first area of an interaction page in response to an input instruction of a question answering task;
display a first reply plan for the first question in a second area of the interaction page in response to the first question;
trigger modification of the first reply plan and display a second reply plan in the second area in response to a modification instruction for the first reply plan; and
display an answer obtained based on the second reply plan in the first area.
